(19) United States
(12) Patent Application Publication
(10) Pub. No.: US 2025/0036323 A1
(43) Pub. Date: Jan. 30, 2025

(54) IMAGE FORMING SYSTEM, METHOD OF EDITING MEDIUM INFORMATION, AND STORAGE MEDIUM

(71) Applicant: CANON KABUSHIKI KAISHA, Tokyo (JP)

(72) Inventor: Yutaka Inoue, Tokyo (JP)

(21) Appl. No.: 18/750,221

(22) Filed: Jun. 21, 2024

(30) Foreign Application Priority Data
Jul. 6, 2023 (JP) 2023-111291

(51) Int. Cl. G06F 3/12

(52) U.S. Cl. CPC G06F 3/1204; G06F 3/1257; G06F 3/1285

(57) ABSTRACT

An image forming system of the present disclosure includes: an obtaining unit configured to obtain medium information in which a value for an adjustment item for controlling an image forming apparatus is set for each of a plurality of print modes; an accepting unit configured to accept an adjustment value set by a user for the adjustment item for one print mode among the plurality of print modes; and a setting unit configured to set a setting value, according to the adjustment value, for the adjustment item corresponding to another print mode differing from the one print mode.

### BACKGROUND OF THE INVENTION

### Field of the Invention

The present disclosure relates to settings of control parameters for an image forming apparatus.

### Description of the Related Art

In image forming systems that perform printing on media such as paper, appropriate color processing is performed by setting parameters suitable for the characteristics of the media. For genuine media, the manufacturer provides medium information with appropriate parameters, color processing tables, and the like defined, but a third-party medium may be used for the user's convenience. In such cases, since the appropriate medium information is not in the user's possession, it can be assumed that the user will get and use medium information with similar characteristics via the Internet, etc.

However, medium information obtained under these circumstances does not necessarily conform to the characteristics of the medium. Therefore, it is necessary for the user to adjust the value of each parameter for each print mode so that appropriate printing can be performed on third-party media. In order to reduce the burden on such a user, the method disclosed in Japanese Patent Laid-Open No. 2009-251229 discloses a method in which a patch is formed on the medium in one of the print modes, then image forming conditions such as a gray scale correction table are set based on the detection result of the patch, and then the conditions are reflected in other print modes if the conditions are matched.

However, there is a wide range of user-adjustable parameters in image forming apparatuses. In addition to the parameters related to color processing, such as the gray scale correction table described above, there are various other control parameters, such as head height according to the thickness of the medium, ink volume according to the paper quality, and heating temperature. It has been a great burden for the user to manually set all of those numerous parameter adjustments for each of the multiple print modes.

The purpose of the present disclosure is to reduce the user workload in editing medium information.

### SUMMARY OF THE INVENTION

An image forming system of the present disclosure includes: an obtaining unit configured to obtain medium information in which a value for an adjustment item for controlling an image forming apparatus is set for each of a plurality of print modes; an accepting unit configured to accept an adjustment value set by a user for the adjustment item for one print mode among the plurality of print modes; and a setting unit configured to set a setting value, according to the adjustment value, for the adjustment item corresponding to another print mode differing from the one print mode.

Further features of the present invention will become apparent from the following description of exemplary embodiments with reference to the attached drawings.

### BRIEF DESCRIPTION OF THE DRAWINGS

FIG. 1 is a diagram illustrating an example of the system configuration of an image forming system;

FIG. 2 is a diagram illustrating an example of the hardware configuration of an image forming apparatus;

FIG. 3 is a diagram illustrating an example of the hardware configuration of an information processing apparatus;

FIG. 4 is a diagram illustrating the functional configuration of the image forming system;

FIG. 5A to FIG. 5C are diagrams representing the data configuration of medium information and medium information files;

FIG. 6 is a diagram illustrating the functional configuration of a medium information editing application;

FIG. 7 is a diagram illustrating an example of the method of obtaining medium information and a registration destination;

FIG. 8 is a diagram illustrating the work process using the medium information editing application;

FIG. 9A is a diagram illustrating a print mode selection screen; FIG. 9B is a diagram illustrating an example of a name editing screen;

FIG. 10 is a diagram illustrating an example of an adjustment screen for each medium;

FIG. 11A and FIG. 11B are diagrams illustrating examples of the adjustment screen for each print mode;

FIG. 12 is a diagram illustrating the data contents of a range table;

FIG. 13 is a diagram illustrating an example of the adjustment values set by the user for the adjustment items in the print mode 1;

FIG. 14 is a flowchart illustrating the processing flow executed by a second print mode adjustment setting unit;

FIG. 15 is a diagram illustrating an example of a confirmation screen for automatically setting the values for the other print modes;

FIG. 16 is a flowchart regarding S1407, using the ink applying amount as an example;

FIG. 17 is a flowchart regarding S1407, using the fixing temperature as an example;

FIG. 18 is a flowchart illustrating a calculation method differing from that of FIG. 16; and

FIG. 19 is a flowchart illustrating a processing flow differing from that of FIG. 17.

### DESCRIPTION OF THE EMBODIMENTS

Hereinafter, a detailed explanation is given of preferable embodiments of the present disclosure with reference to the accompanying drawings. Note that each embodiment described below is not intended to limit the scope of the patent claims, and all of the combinations of the features explained in the present embodiments are not necessarily essential.

### First Embodiment

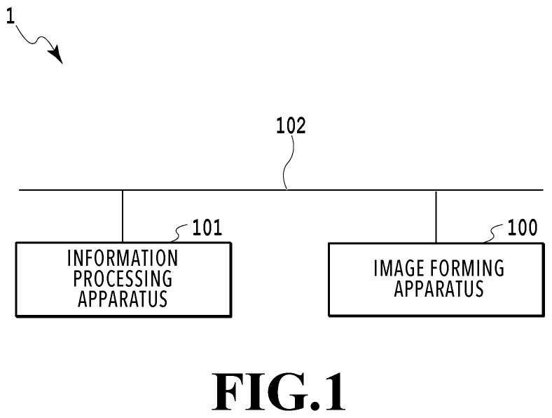

FIG. 1 is a diagram illustrating an example of the system configuration in the network environment of the image forming system 1 of the present disclosure. As illustrated in FIG. 1, the image forming system 1 is equipped with the information processing apparatus 101 and the image forming apparatus 100. The information processing apparatus 101 can be communicatively connected to the image forming apparatus 100 via the network 102. The information processing apparatus 101 creates a print job and sends the print job to the image forming apparatus 100.

The system configuration illustrated in FIG. 1 is an example with the one image forming apparatus 100, but there is no limitation to this, and a configuration equipped with multiple image forming apparatuses 100 is also possible. There may also be a configuration equipped with multiple information processing apparatuses 101. Further, if the functions provided in the information processing apparatus 101 are incorporated in the image forming apparatus 100, the image forming system 1 may be configured with the image forming apparatus 100 alone.

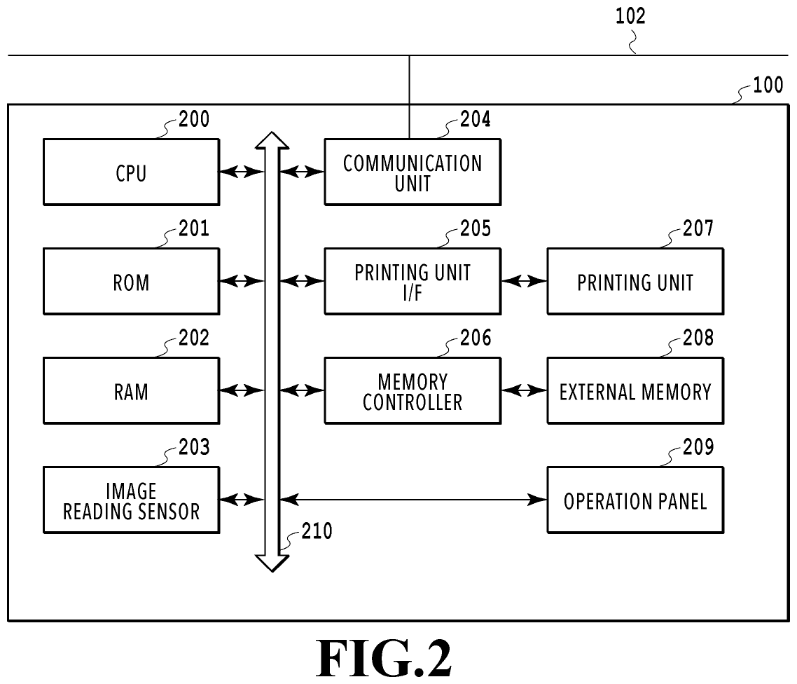

FIG. 2 is a diagram illustrating an example of the hardware configuration of the image forming apparatus 100. The image forming apparatus 100 is equipped with the CPU 200, the ROM 201, the RAM 202, the image reading sensor 203, the communication unit 204, the printing unit I/F 205, the memory controller 206, the printing unit 207, the external memory 208, the operation panel 209, and the like. Each unit is connected via the system bus 210.

The CPU 200 executes processing based on a control program or the like stored in the program storage area of the ROM 201 or a control program or the like stored in the external memory 208, and controls the operation of each unit of the image forming apparatus 100. The CPU 200 outputs an image signal as output information to the printing unit (the printer engine) 207 connected to the printing unit I/F 205 via the system bus 210. The CPU 200 is capable of communication processing with the information processing apparatus 101 via the communication unit 204, and notifies the information processing apparatus 101 of information inside the image forming apparatus 100. Further, the CPU 200 receives output information to be output to the printing unit 207 via the communication unit 204.

The RAM 202 functions as a main memory, a work area, and the like, of the CPU 200. Note that the RAM 202 is used as an output information loading area, an environment data storage area, non-volatile memory, and the like. Access to the external memory 208, which may be a hard disk drive (HDD), a memory card, or the like, is controlled by the memory controller 206.

The external memory 208 can be connected as an option. The external memory 208 can store font data, emulation programs, form data, information about a sheet (a medium) registered in the image forming apparatus 100, the attribute information of a sheet (a medium), or the like. The operation panel 209 is equipped with a touch panel that also serves as a display device, and displays various information input from the CPU 200 in addition to accepting operations from the user and outputting operation signals to the CPU 200.

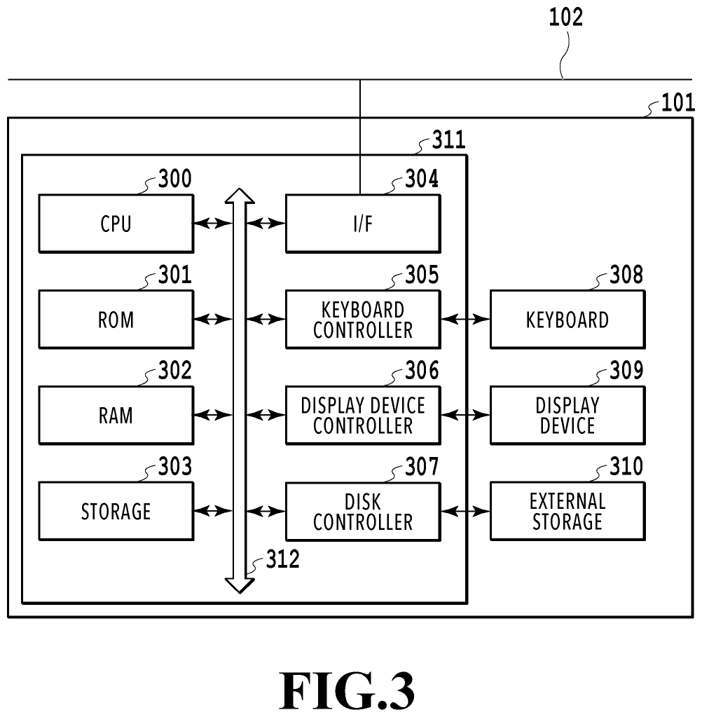

FIG. 3 is a block diagram illustrating an example of the configuration of a computer terminal used as the information processing apparatus 101. The computer terminal has the CPU 300, the ROM 301, the RAM 302, the storage 303, the I/F 304, the keyboard controller 305, the display device controller 306, and the disk controller 307 in the internal 311. Each unit is connected by the main bus 312. The keyboard 308 is connected to the keyboard controller 305. The display device 309 is connected to the display device controller 306. The external storage 310 is connected to the disk controller 307.

The CPU 300 reads various programs, such as control programs, system programs, and application programs stored in the storage 303 or the external storage 310 into the RAM 302. The CPU 300 executes the various programs read into the RAM 302 to perform various data processing and perform display control of the display device 309. The CPU 300 may read a control program or the like from the ROM 301. Note that it is also possible that the CPU 300 is a dedicated circuit such as an ASIC. The CPU 300, a dedicated circuit, or the like is an example of a hardware circuit or hardware processor.

The disk controller 307 controls access to the external storage 310, which may be an HD, a CD-ROM, a DVD-ROM, a USB, or the like. The RAM 302 is configured so that the capacity thereof can be expanded by an optional RAM or the like that is not illustrated in the drawings, and is mainly utilized as a work area for the CPU 300. The keyboard controller 305 controls input from the keyboard 308, a pointing device that is not illustrated in the drawings, and the like. The display device controller 306 controls the displaying of the display device 309. The CPU 300 can process communications with the image forming apparatus 100 via the I/F 304.

Note that, in the present embodiment, unless otherwise specified, the CPU 300 controls each unit connected to the main bus 312 via the main bus 312.

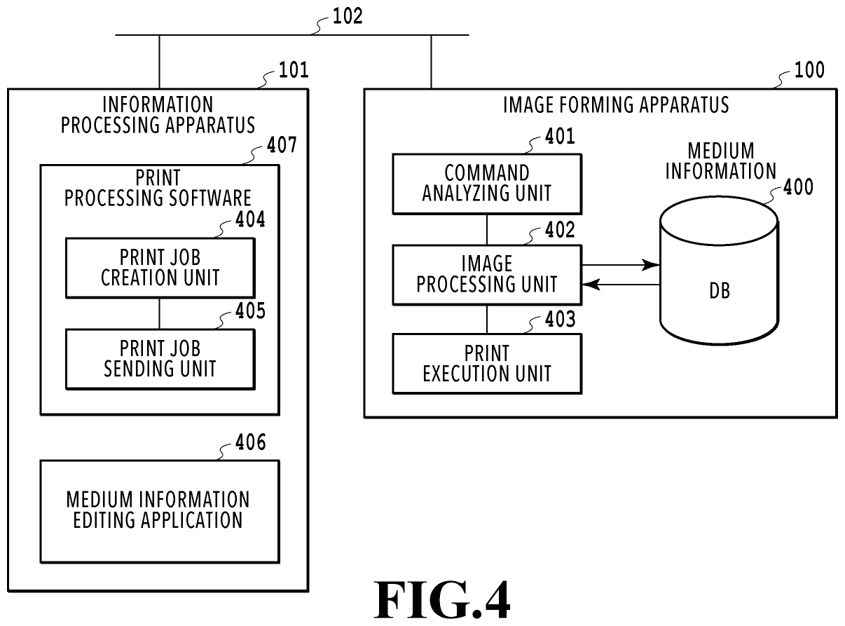

FIG. 4 is a block diagram illustrating an outline of the functions included in the image forming system 1.

As illustrated in FIG. 4, the information processing apparatus 101 has programs such as a printer driver, the print processing software 407, and the medium information editing application 406. The CPU 300 reads and executes these programs to function as the print job creation unit 404, the print job sending unit 405, and the medium information editing unit.

The image forming apparatus 100 has the command analyzing unit 401, the image processing unit 402, and the print execution unit 403. Each of these functional units is implemented by a program executed by the CPU 200, a dedicated circuit, or the like. The medium information 400 is stored in the non-volatile memory area of the RAM 202 of the image forming apparatus 100.

In a case where execution of printing is designated in a program such as the printer driver or the print processing software 407 in the information processing apparatus 101, the print job creation unit 404 adds a command to execute printing. The print job sending unit 405 sends the print job created in the print job creation unit 404 to the image forming apparatus 100 via the network 102.

After a print job is accepted in the image forming apparatus 100, the command analyzing unit 401 analyzes the contents of the printing instruction command which is set in the print job. The image processing unit 402 determines what image processing process to use and what kind of image processing to carry out, depending on the contents of the command.

The medium information 400 is a dataset that includes the print control parameters and the image processing parameters (a color processing table: a LUT) and the like for each sheet (media) type and for each print mode. The image processing unit 402 obtains the necessary LUT from the medium information 400 according to the media type and the print mode, performs image processing such as color conversion, and passes the halftone processed data to the print execution unit 403.

The print execution unit 403 obtains the values of the print control parameters from the medium information 400 according to the media type and the print mode, and executes the print processing while controlling each unit of the image forming apparatus 100. This is designed to perform media-appropriate image processing and device control.

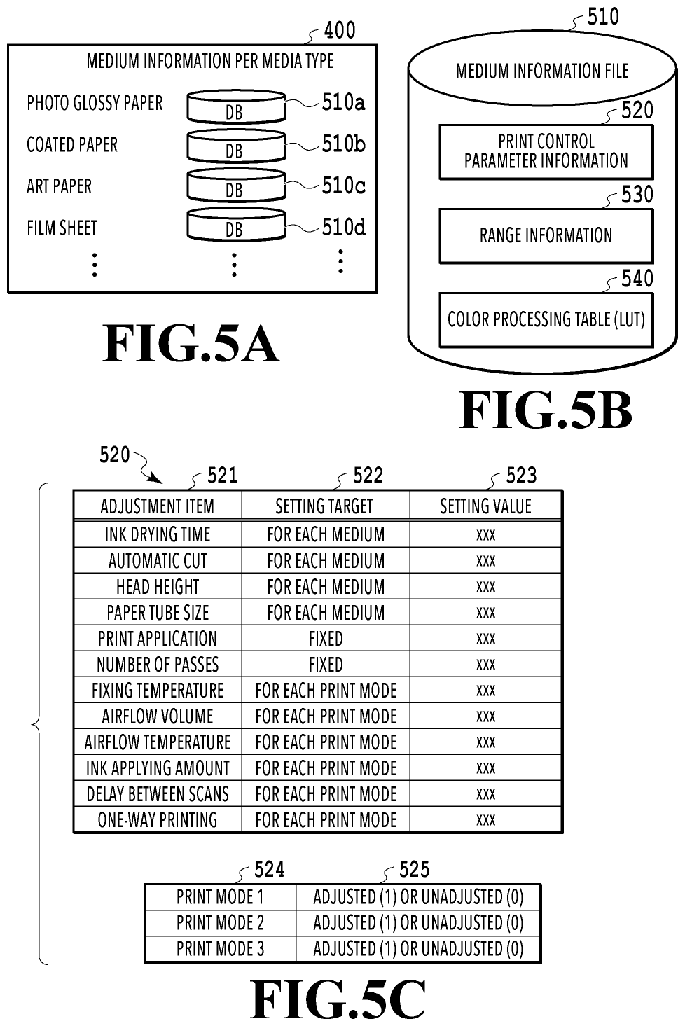

For example, as illustrated in FIG. 5A to FIG. 5C, the medium information 400 stores multiple medium information files 510 per media type. The medium information files 510 per media type store a plurality of print control parameter information 520, the color processing tables (LUTs) 540, and the like, respectively.

FIG. 5A is a diagram illustrating the data configuration of the medium information 400. The medium information 400 stores the medium information files 510a, 510b, 510c, 510d, etc., each corresponding to a type of media. In the example in FIG. 5A, the medium information files 510a, 510b, 510c, 510d, etc., are stored respectively for multiple types of media, such as for photo glossy paper, for coated paper, for art paper, for film sheet, etc. In the following explanation, the medium information files 510a, 510b, 510c, 510d, etc., corresponding to the respective types of media are collectively referred to as the medium information files 510 per media type in a case where there is no distinguishing.

FIG. 5B is a diagram illustrating the data configuration of the medium information files 510 per media type. The medium information files 510 per media type include the print control parameter information 520, the range information (the range table 530), and the multiple color processing tables (LUTs) 540. The description format of the medium information files 510 per media type can be configured with binary, XML, or the like.

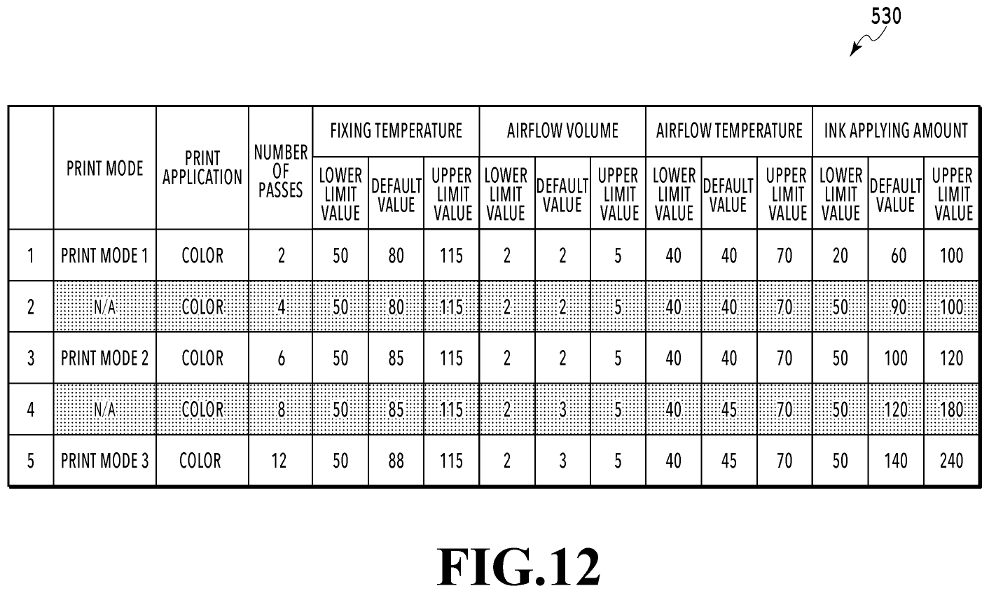

The range table 530 is information that defines the range of variable values and default values for each print control parameter (for each of the adjustment items 521). The details of the range table 530 are described later (FIG. 12).

The color processing tables (LUTs) 540 are examples of parameters for image processing used in image processing performed by the image processing unit 402. The color processing tables (LUTs) 540 are multiple LUTs corresponding to the print control parameters (the adjustment items 521) created and stored by the manufacturer. For example, the LUTs corresponding to the setting values of the “INK APPLYING AMOUNT” are stored.

FIG. 5C is a diagram illustrating an example of the print control parameter information 520. The print control parameter information 520 stores the setting target 522 and the setting value 523 for each of the multiple adjustment items 521.

The adjustment items 521 are parameters related to device control, such as the ink drying time, the automatic cut setting, the head height, the paper tube size, the fixing temperature, the airflow volume, the airflow temperature, the ink applying amount, the delay between scans, one-way printing, and the like. Fixed values for the print modes are set for the print application and the number of passes. Note that the types of the adjustment items 521 are not limited to these and may include other parameters.

The setting values 523 for the respective adjustment items 521 are reflected in a case where the print execution unit 403 executes the print processing. For example, in a case where the “HEAD HEIGHT” is stored in the adjustment items 521 of the print control parameter information 520, the CPU 200 of the image forming apparatus 100 reads the setting value 523 corresponding to the “HEAD HEIGHT” and adjusts the head height of the head mechanism in the printing unit 207.

The setting target 522 is information indicating whether the adjustment item 521 can be set to a value for each print mode, is set to a common value for each medium, i.e., across each print mode, or is set to a fixed value for the print mode.

In the example in FIG. 5C, the ink drying time, the automatic cut setting, the head height, and the paper tube size are defined as adjustment items for each medium. In other words, values that are common across each print mode are set. The fixing temperature, the airflow volume, the airflow temperature, the ink applying amount, the delay between scans, and one-way printing are defined as adjustment items that are adjustable for each print mode. The print application and the number of passes are set to fixed values for the print modes. In a case of changing the values for the print application and the number of passes, the user performs processing to create a new print mode.

In addition, the print control parameter information 520 stores the print mode adjusted flag 525. The print mode adjusted flag 525 stores information indicating whether the user has adjusted or has not adjusted the setting values 523 of the adjustment items 521 for each of the print modes 524. The value of the print mode adjusted flag 525 is set to “1” if there has been adjustment and “O” if there has not been adjustment.

Next, an explanation is given of the medium information editing application 406. The medium information editing application 406 is an application program that obtains the medium information 400 and accepts editing of the medium information 400 by the user.

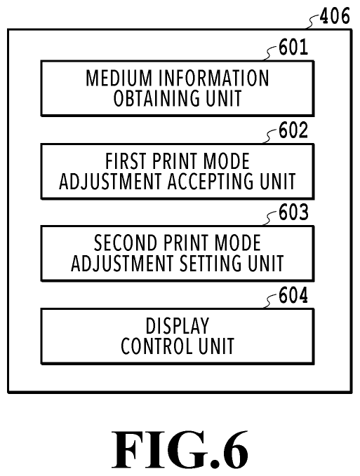

FIG. 6 is a diagram illustrating the functional configuration of the medium information editing application 406 of the present embodiment. As illustrated in the drawing, the medium information editing application 406 has the medium information obtaining unit 601, the first print mode adjustment accepting unit 602, the second print mode adjustment setting unit 603, and the display control unit 604. The CPU 300 of the information processing apparatus 101 reads the medium information editing application 406 stored in the storage 303, the external storage 310, or the ROM 301, loads the medium information editing application 406 to the RAM 302, and executes the medium information editing application 406.

The medium information obtaining unit 601 obtains the medium information 400 or the medium information files 510 per media type (hereinafter collectively referred to as the medium information 400) and stores the medium information 400 in the RAM 302 of the information processing apparatus 101. The method of obtaining the medium information is described later.

The first print mode adjustment accepting unit 602 accepts an adjustment value from the user for each of the adjustment items for one print mode (the first print mode) among the multiple print modes included in the medium information 400 obtained by the medium information obtaining unit 601.

The second print mode adjustment setting unit 603 sets the setting values for the corresponding adjustment items in the other print modes (the second print modes), which are different from the first print mode, according to the adjustment values for each adjustment item accepted by the first print mode adjustment accepting unit 602. The second print mode is one or multiple print modes.

Note that the medium information 400 stores parameters for image processing, such as the multiple color processing tables (LUTs) 540. In a case where an adjustment item related to the color processing tables (LUTs) 540 is adjusted in one print mode, the first print mode adjustment accepting unit 602 changes the color processing table (LUT) 540 to be applied according to the adjustment value. Similarly, the second print mode adjustment setting unit 603 changes the setting values in the other print modes, and then changes the color processing tables (LUTs) 540 to be applied accordingly. The adjustment items related to the color processing tables (LUTs) 540 are, for example, the “INK APPLYING AMOUNT” and the like.

The display control unit 604 displays various screens for editing the medium information 400. The user checks and edits the contents of the medium information 400 via the screens. The screens displayed in the medium information editing application 406 are described later.

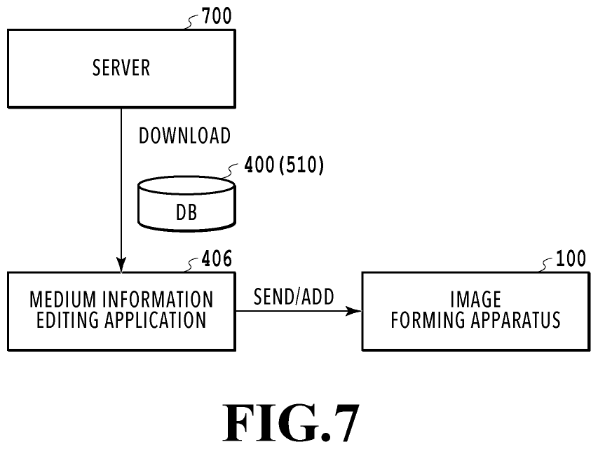

Hereinafter, an explanation is given of an example of the method for obtaining the medium information 400 by the medium information obtaining unit 601. FIG. 7 is a diagram illustrating an example of the method for obtaining the medium information 400 and the registration destination.

The medium information 400 is stored on the server 700, for example. The server 700 is in the form of a cloud or GDLS server, which is assumed to be accessed by the user through the medium information editing application 406 of the information processing apparatus 101. The medium information editing application 406 accesses the server 700, downloads the medium information 400, and then sends the medium information 400 to the image forming apparatus 100.

The image forming apparatus 100 stores the received medium information 400 in the RAM 202. Although the medium information 400 received from the server 700 can be utilized as-is, the medium information 400 does not necessarily match the characteristics of the sheet (the medium) that is actually fed and used. Therefore, the user edits the adjustable items (the parameters) in the medium information 400 according to the medium actually utilized.

Note that, in the present embodiment, an explanation is hereinafter given of an example where editing is performed on the medium information 400 in the information processing apparatus 101 and the edited medium information is sent to the image forming apparatus 100. The CPU 300 of the information processing apparatus 101 reads and executes the medium information editing application 406 stored in the storage 303 or the like, and functions as the medium information obtaining unit 601, the first print mode adjustment accepting unit 602, the second print mode adjustment setting unit 603, and the display control unit 604 in FIG. 6.

Further, not being limited to this example, the CPU 200 of the image forming apparatus 100 may read and execute the medium information editing application 406 stored in the RAM 202 or the like. In other words, the image forming apparatus 100 may be made to function as the medium information obtaining unit 601, the first print mode adjustment accepting unit 602, the second print mode adjustment setting unit 603, and the display control unit 604. Further, the entire image forming system 1 may be configured to implement the entire functions illustrated in FIG. 6, such as having the information processing apparatus 101 function as the medium information obtaining unit 601 and having the image forming apparatus 100 function as the first print mode adjustment accepting unit 602, the second print mode adjustment setting unit 603, and the display control unit 604.

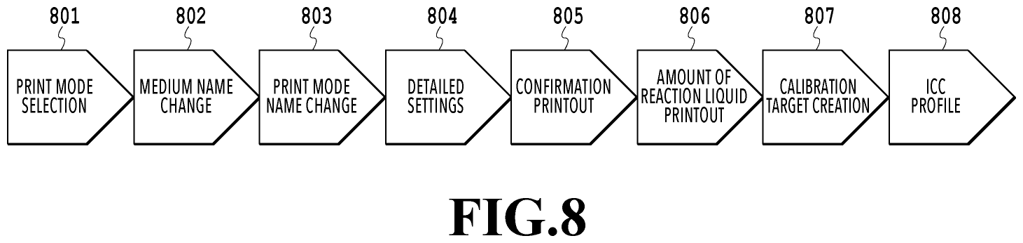

FIG. 8 is a diagram illustrating the work process using the medium information editing application 406. The user launches the medium information editing application 406 to perform editing on the medium information 400 to fit the medium to be utilized. In the editing work, the user first selects the print mode to be adjusted in the process 801. Next, in the processes 802 and 803, the user changes the medium name and the print mode name of the downloaded medium information 400 as needed. Then, in the process 804, the user sets the setting value 523 for each of the adjustment items 521 via the editing screen for detailed settings. The editing screen for detailed settings is described later.

After the detailed settings, in the process 805, a confirmation printout can be performed to confirm the setting content on printed material. This is followed by a printout to check the amount of reaction liquid in the process 806. In the process 807, the image forming apparatus 100 is instructed to create a calibration target, and in the process 808, a created ICC profile is selected in a case where the ICC profile is to be used.

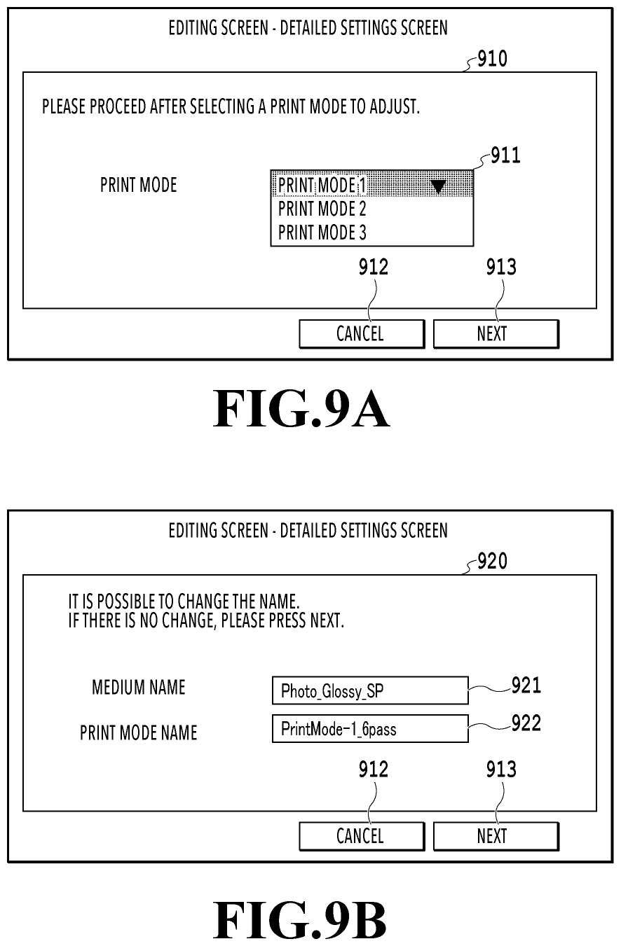

Hereinafter, with reference to FIG. 9A through FIG. 11B, an explanation is given of the operation screens of the medium information editing application 406 that are displayed in each process.

FIG. 9A is a diagram illustrating an example of the print mode selection screen 910 displayed in the process 801. Before entering the editing screen for the adjustment items, the CPU 300 displays the print mode selection screen 910, which accepts the selection of which print mode to adjust. Subsequent changes in the detailed settings of the process 804 are changes in values within this selected print mode.

As illustrated in FIG. 9A, the print mode selection screen 910 displays the list 911 of the selectable print modes. The currently selected print mode may be displayed with a hatched area, marks, etc. In a case where the “CANCEL” button 912 is operated, the input contents are erased. In a case where the “NEXT” button 913 is operated, the screen transitions to the next screen.

FIG. 9B is a diagram illustrating an example of the name editing screen 920 displayed in the processes 802 and 803. The medium name entry field 921 and the print mode name entry field 922 are provided in the name editing screen 920 to accept changes to the medium name and the print mode name.

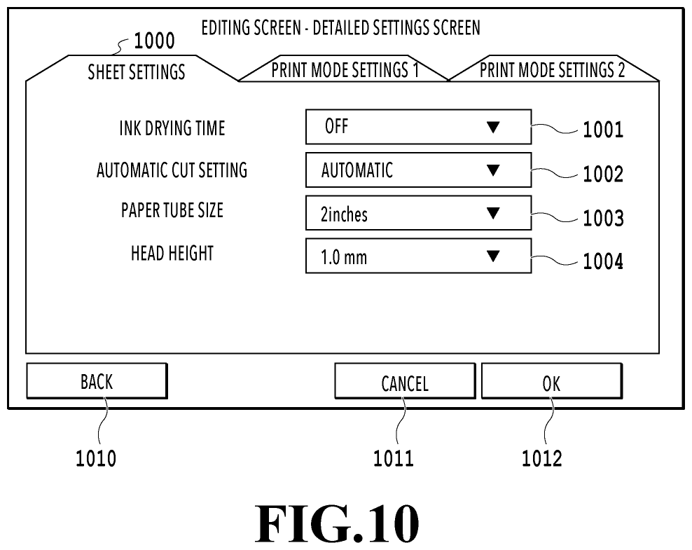

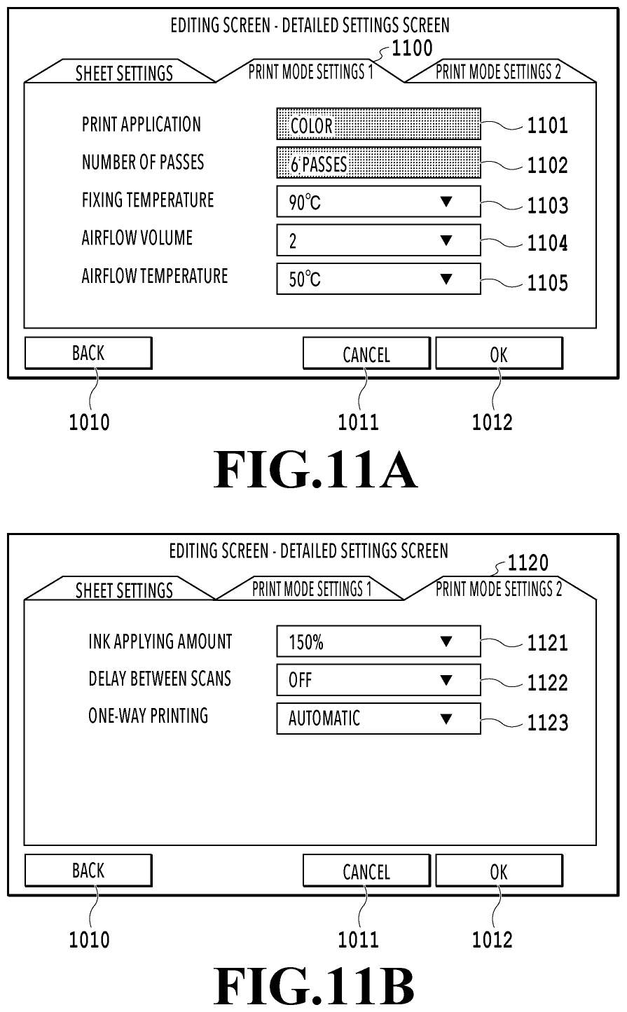

After that, the screen transitions to the editing screen for detailed settings illustrated in FIG. 10, FIG. 11A, and FIG. 11B. The editing screen for detailed settings is equipped with each of the adjustment screen 1000 (FIG. 10) for each medium (sheet) and the adjustment screens 1100 and 1120 (FIG. 11A and FIG. 11B) for each print mode. The values set on the adjustment screen 1000 for each medium are valid on a per media type basis and are common values for all print modes.

FIG. 10 is a diagram illustrating an example of the adjustment screen 1000 for each medium. The setting fields 1001, 1002, 1003, and 1004 for the adjustment items of the “INK DRYING TIME”, the “AUTOMATIC CUT SETTING,” the “PAPER TUBE SIZE,” and the “HEAD HEIGHT,” respectively, are provided on the adjustment screen 1000. The setting fields 1001 through 1004 display the values that can be set in the form of a pull-down list, for example. These adjustment items of the “INK DRYING TIME” the “AUTOMATIC CUT SETTING,” the “PAPER TUBE SIZE,” and the “HEAD HEIGHT” are set to “FOR EACH MEDIUM” as the setting target 522, as illustrated in the print control parameter information 520 in FIG. 5C.

On the adjustment screen 1000, if the “CANCEL” button 1011 is operated, the input contents are erased. If the “OK” button 1012 is operated, the screen transitions to the next screen. If the “BACK” button 1010 is operated, the user can return to the previous screen and redo the settings.

FIG. 11A is a diagram illustrating an example of the adjustment screen 1100 for each print mode. The setting fields 1101 through 1105 for the adjustment items of the “PRINT APPLICATION,” the “NUMBER OF PASSES,” the “FIXING TEMPERATURE,” the “AIRFLOW VOLUME,” and the “AIRFLOW TEMPERATURE,” respectively, are provided on the adjustment screen 1100. The “PRINT APPLICATION” and the “NUMBER OF PASSES” cannot be changed because the information stored in the setting target 522 is “FIXED,” and thus, the setting values 523 defined in the print control parameter information 520 are displayed in the setting fields 1101 and 1102.

Values that can be set are displayed in the form of, for example, a pull-down list or the like in the setting fields 1103 through 1105 for the “FIXING TEMPERATURE,” the “AIRFLOW VOLUME,” and the “AIRFLOW TEMPERATURE.” The values that can be set are values in a range from the upper limit value to the lower limit value defined in the range table 530. Note that in the initial display state of the adjustment screen 1100, the default values defined in the range information, for example the range table 530, are displayed.

FIG. 11B is the adjustment screen 1120 for each print mode as well. The setting fields 1121 through 1123 for the adjustment items of the “INK APPLYING AMOUNT” the “DELAY BETWEEN SCANS,” and “ONE-WAY PRINTING,” respectively, are provided on the adjustment screen 1120. Values that can be set are displayed in the form of, for example, a pull-down list or the like in the setting fields 1121 through 1123. The values that can be set are obtained from the range information, which defines upper limit values, lower limit values, and default values, similar to the range table 530. In the initial display state, the default values defined in the range information are displayed.

Each adjustment item illustrated in FIG. 11A and FIG. 11B is set to “FOR EACH PRINT MODE” as the setting target 522, as illustrated in the print control parameter information 520 in FIG. 5C. The values set on the adjustment screens 1100 and 1120 for each print mode are valid on a per print mode basis, and the setting values are valid only in the selected print mode.

FIG. 12 is a diagram illustrating an example of the range table 530, which describes the range of values that can be adjusted among the adjustment items. In the example in FIG. 12, there are multiple print modes supported by the relevant medium, and for each print mode, ranges of values that can be set (lower limit values to upper limit values) and default values are stored for multiple adjustment items.

In the example in FIG. 12, among the multiple print modes corresponding to the image forming apparatus 100, the print modes supported by the medium information files 510 downloaded from the server 700 are illustrated in white frames. Among print modes No. 1 through No. 5, the print modes that can actually be used are the “PRINT MODE 1,” the “PRINT MODE 2,” and the “PRINT MODE 3.” The print modes that are grayed out and labeled as “N/A” are print modes that have been deleted or for which a print mode name was not set at the time this medium information file 510 was created.

In FIG. 12, an example where there are three print modes is illustrated, but there is no limitation to three. The range table 530 is viewed as, for example, in the print mode 1, the “PRINT APPLICATION” is “COLOR,” the “NUMBER OF PASSES” is a fixed value of “2 PASSES,” and the “FIXING TEMPERATURE” has a range of “50 to 115”C.° with a default value of “80”C.°.

Further, the “AIRFLOW VOLUME” has a range of “2 to 5” with a default value of “2.” The “AIRFLOW TEMPERATURE” has a range of “40 to 70” with a default value of “40.” The “INK APPLYING AMOUNT” has a range of “20 to 100” with a default value of “60.” The print modes 2 and 3 similarly have the upper limit value, the lower limit value, and the default value defined for each adjustable adjustment item.

Note that the format of the data may be binary, in the form of a header of some kind, or described in a format such as XML. The range table 530 is maintained as static information that can be referenced.

Further, as a way of using the range table 530, the lower limit values, the upper limit values, and the default values of the range table 530 may be reflected in a case of displaying in a list the values that can be set for each adjustment item in the adjustment screens 1000, 1100, and 1120 illustrated in FIG. 10, FIG. 11A, and FIG. 11B.

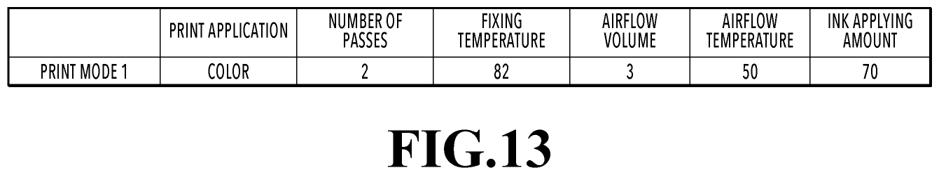

FIG. 13 is a diagram illustrating an example of the adjustment values that are set by the user. The case is that, in the adjustment screens 1100 and 1120 illustrated in FIG. 11A and FIG. 11B of the medium information editing application 406, the user edited each adjustment item in the print mode 1, for example. The setting values for each of the adjustment items in the print mode 1 are set as “COLOR” for the “PRINT APPLICATION,” “2” for the “NUMBER OF PASSES,” “82”C.° for the “FIXING TEMPERATURE,” “3” for the “AIRFLOW VOLUME,” “50”C.° for the “AIRFLOW TEMPERATURE,” and “70” for the “INK APPLYING AMOUNT.”

Compared to the default values for the print mode 1 in the range table 530 in FIG. 12, the “FIXING TEMPERATURE” has been changed “+2”C.°, the “AIRFLOW VOLUME” “+1”, the “AIRFLOW TEMPERATURE” “+10”C.°, and the “INK APPLYING AMOUNT” “+10.”

If the adjustment values in the print mode 1 are set, the CPU 300 (the medium information editing application 406) sets the print mode adjusted flag 525 corresponding to the “PRINT MODE 1” in FIG. 5C to “ADJUSTED (1)”.

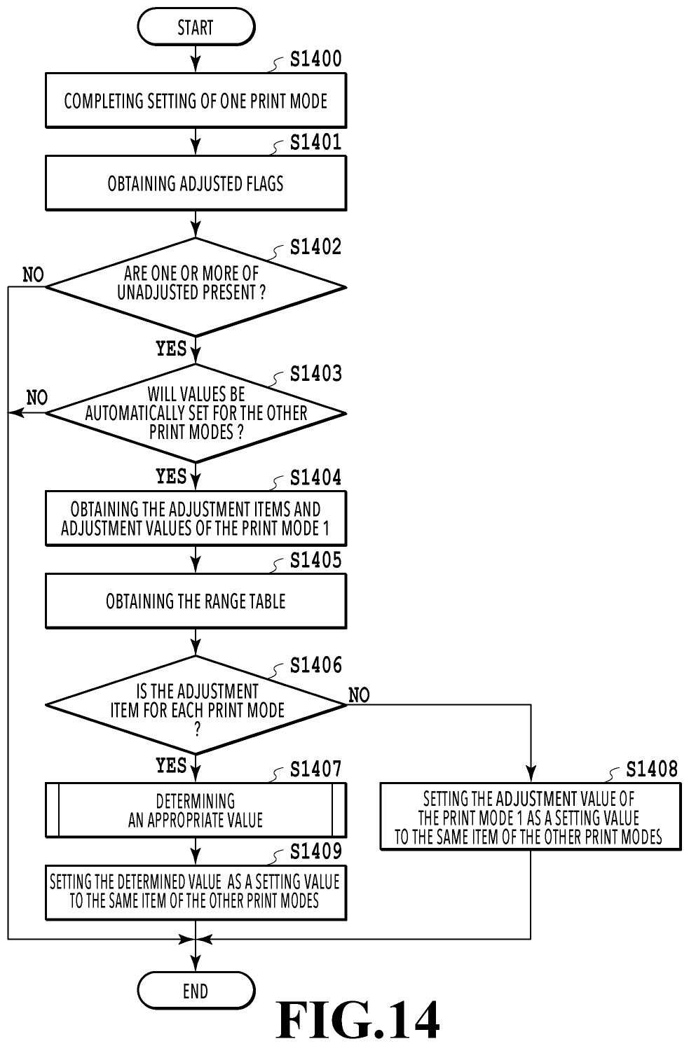

An explanation is hereinafter given of the flow of the processing executed by the second print mode adjustment setting unit 603 (the CPU 300). FIG. 14 is a flowchart illustrating the processing flow of reflecting the appropriate values in the other print modes (the second print modes) in the medium information editing application 406. The following processing illustrated in the flowchart is executed by the CPU 300 of the information processing apparatus 101 by reading the medium information editing application 406 stored in the external storage 310 or the like and loading it into the RAM 302. In the following explanation, the symbol “S” represents a step.

In S1400, if the user performs setting of the setting values for one print mode as illustrated in FIG. 13, the CPU 300 starts the present flowchart. In S1401, the CPU 300 obtains the value of the print mode adjusted flag 525 held in the print control parameter information 520. In this processing, the CPU 300 obtains information on whether the print mode has been adjusted or unadjusted for all the print modes 1 through 3.

In S1402, the CPU 300 checks whether one or more of the flags 525 representing unadjusted (0) are present. In a case where none of the flags 525 representing unadjusted (0) are present (S1402; NO), the processing ends in the present flowchart as there is no need to adjust. In a case where one or more of the flags 525 representing unadjusted (0) are present (S1402; YES), the processing proceeds to S1403.

In S1403, the CPU 300 inquires with the user if it is OK to automatically set appropriate values for the other unadjusted print modes based on the adjusted print mode values. The method of inquiry is, for example, to display a confirmation message on the screen of the display device 309.

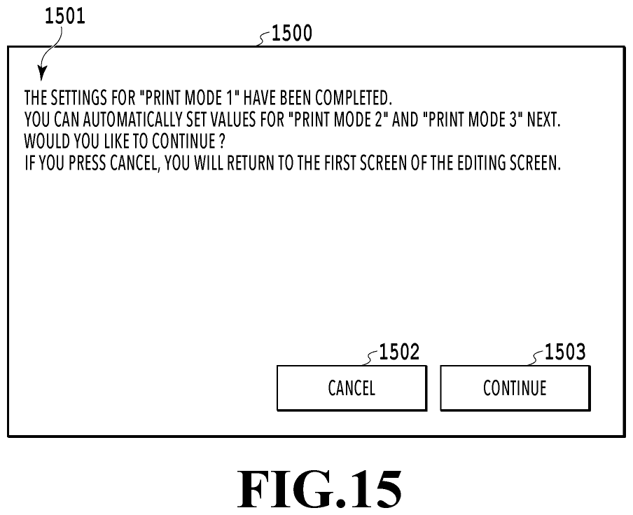

FIG. 15 is a diagram illustrating an example of the confirmation screen 1500 for checking whether or not to automatically set the values of the other print modes. As illustrated in FIG. 15, the confirmation screen 1500 displays the message 1501, such as “THE SETTINGS FOR ‘PRINT MODE 1’ HAVE BEEN COMPLETED. YOU CAN AUTOMATICALLY SET VALUES FOR ‘PRINT MODE 2’ AND ‘PRINT MODE 3’ NEXT. WOULD YOU LIKE TO CONTINUE?”

If the “CANCEL” button 1502 is operated on the confirmation screen 1500 and automatic setting is not performed (S1403; NO), the processing in the present flowchart ends. After ending, it is possible to return to the original screen and end the adjustment itself, or it is possible to transition to the print mode selection screen 910 in FIG. 9A, select another print mode, and accept manual settings by the user. If the “CONTINUE” button 1503 is operated and it is confirmed to perform the automatic setting (S1403; YES), the processing proceeds to S1404.

In S1404, the CPU 300 obtains the adjustment items and the adjustment values for the print mode 1, which is the adjusted print mode. The adjustment items and the adjustment values to be obtained are the contents illustrated in FIG. 13.

In S1405, the CPU 300 obtains the range table 530.

In S1406, the CPU 300 references the information of the setting target 522 for each adjustment item to determine whether the adjustment item is for each print mode or for each medium. In a case where the item is an adjustment item for each print mode (S1406; YES), the processing proceeds to S1407. In a case where the item is an adjustment item for each medium (S1406; NO), the processing proceeds to S1408.

In S1408, the CPU 300 determines that the adjustment item is common to all the print modes and sets the adjustment value set in the print mode 1 directly to the corresponding adjustment items in the other print modes.

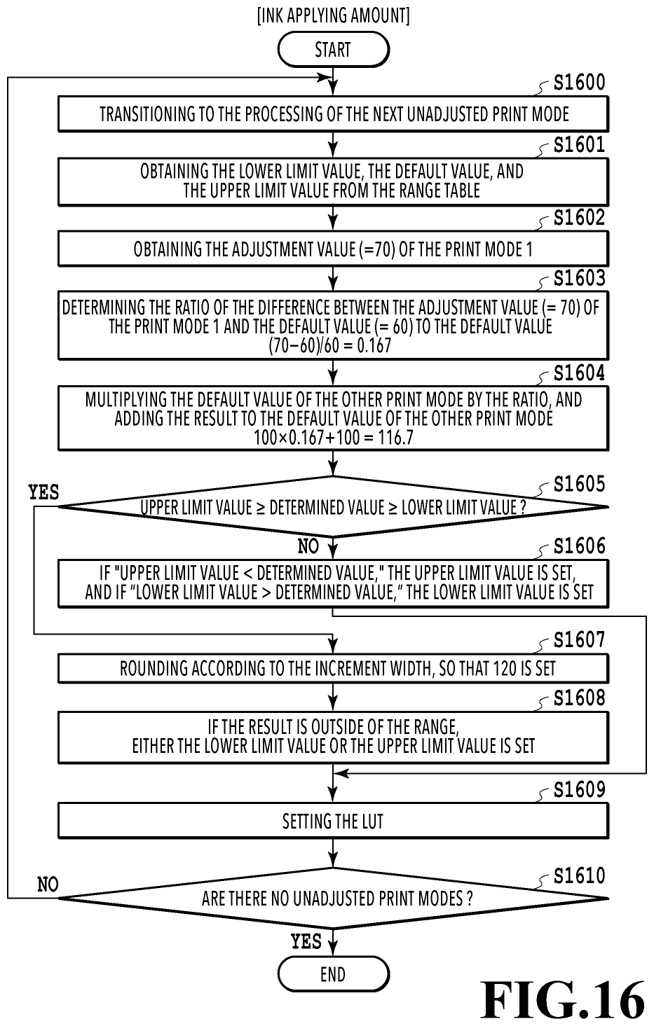

In S1407, the CPU 300 executes processing to determine the appropriate values for the other print modes based on the range table 530 and the adjustment value set in the print mode 1. The details of processing in S1407 are described below (FIG. 16).

In S1409, the CPU 300 sets the value determined in S1407 to the corresponding adjustment items in the other print modes. In this way, the values are set for the relevant items for each print mode in the print control parameter information 520.

FIG. 16 is the processing flowchart regarding S1407, with the ink applying amount as an example. In S1600, the CPU 300 transitions the processing to the next unadjusted print mode. In a case where the print mode 2 and the print mode 3 are present as the unadjusted print modes, the print mode 2, which follows the print mode 1, is the processing target for performing subsequent processing.

In S1601, the CPU 300 obtains the lower limit value, the default value, and the upper limit value of the ink applying amount from the range table 530. In S1602, the CPU 300 obtains the adjustment value (=70) of the ink applying amount for the already set print mode 1.

In S1603, the CPU 300 determines the difference between the adjustment value set in the print mode 1 (=70) and the default value in the print mode 1 (=60), and then determines the ratio of the difference determined (the adjustment width) to the default value. In this example, the calculation result is (70-60)/60=+0.167.

In S1604, the CPU 300 multiplies the default value for the print mode 2 (=100) by the ratio determined in S1603 (+0.167) and adds the result to the default value for the ink applying amount in the print mode 2. The formula in this case is 100×(+0.167)+100=116.7.

In S1605, the CPU 300 checks whether the value determined in S1604 is between the lower limit value and the upper limit value of the ink applying amount in the print mode 2. If the value is not within the range (S1605; NO), the processing proceeds to S1606. If the value is within the range (S1605; YES), the processing proceeds to S1607.

In S1606, the CPU 300 compares the value determined in S1604 with the upper limit value and the lower limit value. In a case where the value determined in S1604 exceeds the upper limit value, the value of the ink applying amount in the print mode 2 is set to the upper limit value. In a case where the value determined in S1604 is below the lower limit value, the value of the ink applying amount in the print mode 2 is set to the lower limit value.

In S1607, the CPU 300 corrects the value according to the increment width of the ink applying amount. For example, in a case where the increment width of the ink applying amount is increments of 10 [%], the value=116.7 determined in S1604 is rounded and corrected to 120[%] to set the value. Note that this increment width corresponds to the increment width at which the color processing table (LUT) 540 stored in the medium information file 510 is created.

In S1608, the CPU 300 checks whether the value set in S1607 (=120) is a value that falls within the range of the ink applying amount in the print mode 2. In a case where the value set in S1607 is greater than the upper limit value, the value set in S1607 is changed to the upper limit value, and in a case where the value is less than the lower limit value, the value set in S1607 is changed to the lower limit value.

Once the processing up to S1608 ends, in S1609, the CPU 300 changes the image processing table (LUT) 540 to be applied in the relevant print mode according to the set value for the “INK APPLYING AMOUNT.”

After that, in S1610, the CPU 300 determines whether there are any other unadjusted print modes. In a case where there is an unadjusted print mode (S1610; NO), the processing proceeds to S1600. Here, the processing from S1601 to S1610 is executed with the print mode 3 as the target, which is the next print mode after the print mode 2. In a case where there are no unadjusted print modes (S1610; YES), the present flowchart ends.

In the determination method of the processing flow described above, the ratio of the difference between the default value and the adjustment value accepted in the print mode 1 to the default value is determined, then the default value of the corresponding adjustment item in the print mode to be set is multiplied by that ratio, and then the result is added to the default value. However, the method of determining the values of the other print modes is not limited to this. For example, a method in which the difference between the value set in the print mode 1 and the default value is added directly to the default value of the print mode 2 is also conceivable.

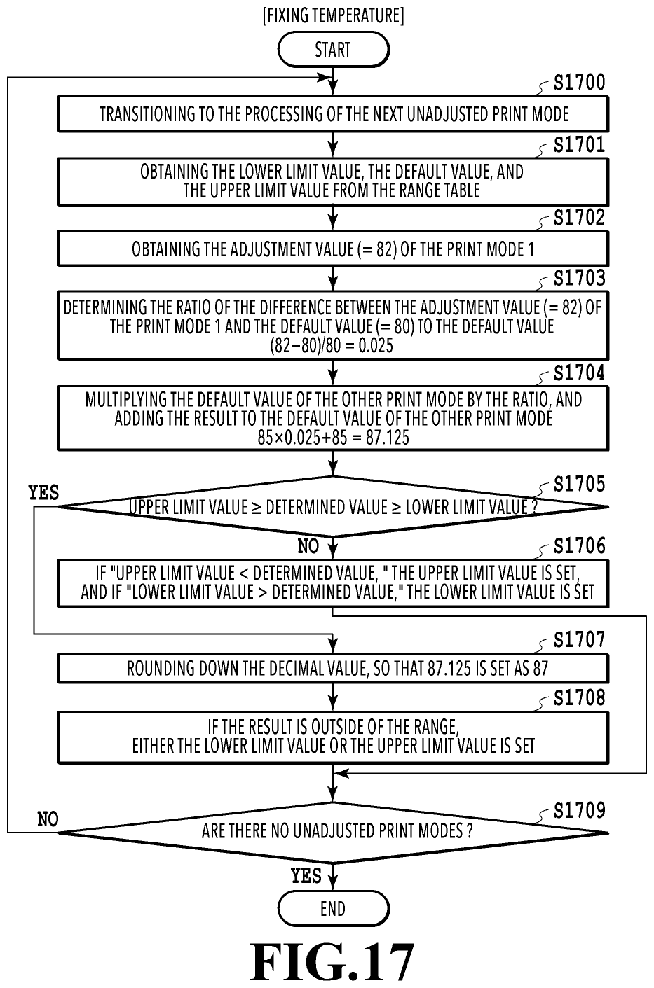

FIG. 17 is the processing flow regarding S1407 in FIG. 14, with the “FIXING TEMPERATURE” as an example. S1700 through S1706, S1708, and S1709 in FIG. 17 have similar details of processing to S1600 through S1606, S1608, and S1610 in FIG. 16, differing only in the calculated values. The part of the processing that differs is S1707. Further, the processing corresponding to the change of the color processing table (LUT) 540 in S1609 is omitted in the flowchart in FIG. 17.

In S1700 through S1703, the CPU 300 determines the difference between the adjustment value (=82) of the print mode 1 and the default value (=80) and determines the ratio of the difference to the default value.

$$The formula for this example is ( 82 - 80 ) / 80 = + 0.025 .$$

In S1704, the CPU 300 multiplies the default value of the “FIXING TEMPERATURE” for the print mode 2 (=85) by the ratio determined in S1703 (+0.025) and adds the result to the default value.

$$The formula is 85 \times ( + 0.025 ) + 85 = 87.125 .$$

The calculation result of S1704 is determined to fall within the range in S1705, and the processing proceeds to S1707.

In S1707, the CPU 300 corrects the value acquired by the calculation so as to become a value accepted by the device targeted for control of the adjustment item. For example, in a case where the value determined by the calculation includes a decimal value, the decimal value shall be rounded down. This is because, although the value determined in S1704 is 87.125, a decimal value cannot be set as the control unit for the heater targeted for control. In this case, the CPU 300 corrects the value to increments of 1[° C.], which can be set for the heater, and then sets the value. Note that in a case where decimal values are accepted for the temperature setting on the device side, the processing in S1707 is not necessary.

As explained above, the present embodiment reduces the user's workload in editing the medium information. Specifically, if the user sets an adjustment value for an adjustment item in one of the multiple print modes, the corresponding adjustment item in another print mode is also set by the image forming system 1 to the setting value corresponding to the adjustment value. The user does not have to make individual adjustments to all the print modes, which makes the editing work of the medium information more efficient. Further, since the appropriate color processing table (LUT) is set by the image forming system 1 according to the values set for the adjustment items in each print mode, appropriate image processing is performed without the user's consciousness, making it possible to provide good image quality.

Furthermore, the setting values to be set for the other print modes are determined based on the ratio of the difference between the default value and the adjustment value set by the user in one print mode to the default value. Accordingly, it is possible to set appropriate setting values reflecting the differences in the settable ranges and the default values in each print mode.

### Second Embodiment

Next, an explanation is given regarding the second embodiment. The configuration and functions of the image forming system 1 in the second embodiment are the same as those in the first embodiment. The difference from the first embodiment is the calculation method in the processing to determine the values of the corresponding adjustment items in the other print modes based on the adjustment value set by the user in one print mode.

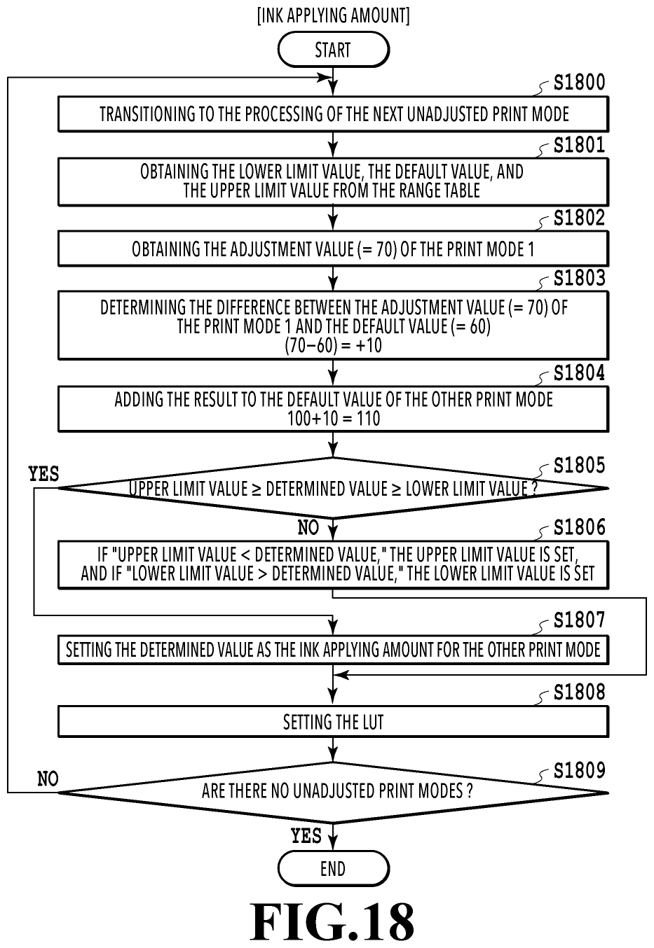

FIG. 18 is the processing flow regarding S1407 in FIG. 14, with the “INK APPLYING AMOUNT” as an example, but the determination method is different from that in FIG. 16. The following explanation focuses on the differences.

S1800 through S1802 in FIG. 18 are the same processing as S1600 through S1602 in FIG. 16. In S1803, the CPU 300 determines the difference between the adjustment value (=70) set in the print mode 1 and the default value (=60).

$$The formula is ( 70 - 60 ) = + 10.$$

In S1804, the CPU 300 adds the value determined in S1803 (=+10) to the default value (=100) for another print mode (the print mode 2).

$$The formula in this case is 100 + 10 = 110.$$

The processing in S1805 through S1809 is the same as the processing in S1605 through S1606 and S1608 through S1610 in FIG. 16. Note that the rounding processing corresponding to S1607 is omitted in the flowchart in FIG. 18.

In S1805, as in S1605, the CPU 300 checks whether the value determined in S1804 is within the range from the lower limit value to the upper limit value obtained in S1801. In a case where the value is not within the range, (S1805; NO), the processing proceeds to S1806. In a case where the value is within the range (S1805; YES), the processing proceeds to S1807.

In S1806, as in S1606, the CPU 300 sets the upper limit value in a case where the value determined in S1804 is greater than the upper limit value. In a case where the value determined in S1804 is less than the lower limit value, the lower limit value is set.

In S1807, the CPU 300 sets the value determined in S1804 to the “INK APPLYING AMOUNT” of the other print mode (the print mode 2). In S1808, the CPU 300 changes the color processing table (LUT) 540 applied to the print mode 2 according to the set value for the ink applying amount. In S1809, the CPU 300 determines whether there are unadjusted print modes. In a case where there is an unadjusted print mode (S1809; NO), the processing proceeds to S1800, so as to transition to the next print mode following the print mode 2 and start the processing. In a case where there are no unadjusted print modes (S1809; YES), the present flowchart ends.

As explained above, the setting values to be set for the other print modes can also be determined by the difference between the default value and the adjustment value set by the user in one print mode.

### Third Embodiment

Next, an explanation is given regarding the third embodiment. The configuration and functions of the image forming system in the third embodiment are the same as those in the first embodiment. The difference from the first embodiment is the processing in a case where the range and the default value defined for an adjustment item adjusted in one print mode are the same range and default value for the corresponding adjustment item in another print mode. In this case, in the third embodiment, the adjustment value set in the one print mode is applied directly to the other print mode.

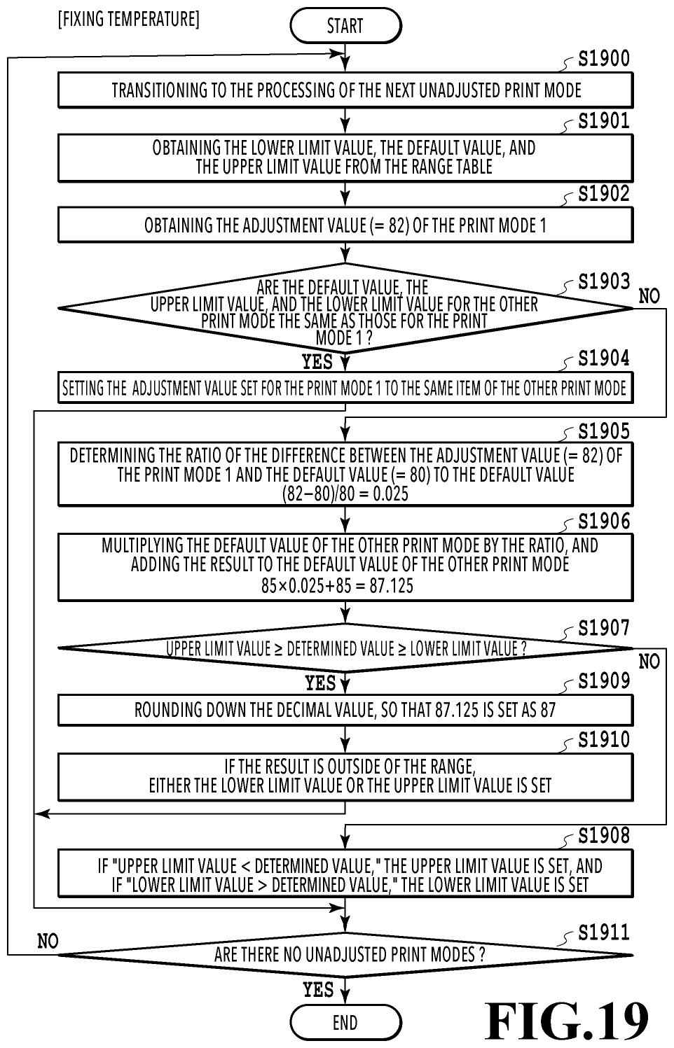

Similar to FIG. 17, FIG. 19 is the processing flow regarding S1407 in FIG. 14, with the “FIXING TEMPERATURE” as an example. The difference between the processing in FIG. 19 and the processing in FIG. 17 is the addition of the processing in S1903 through S1904.

S1900 through S1902 is the same processing as S1700 through S1702 in FIG. 17. In S1903, the CPU 300 determines whether the range and the default value of the adjusted adjustment item are the same range and default value for the corresponding adjustment item in the other print mode targeted for adjusting. In a case where the range and the default value are the same, the processing proceeds to S1904, and in a case where the range and the default value are not the same, the processing proceeds to S1905.

In S1904, the CPU 300 sets the adjustment value set in the print mode 1 directly to the other print mode.

Regarding the range and default value for the adjustment item of the “FIXING TEMPERATURE,” assuming that the same range and default value are defined for the print modes 1, 2, and 3. In a case where the adjustment value “85” is set in the print mode 1, the CPU 300 also sets the fixing temperature in the other print modes 2 and 3 to “85.”

S1905 through S1911 is the same processing as S1703 through S1709 in FIG. 17. That is, in the processing of S1905 through 1910, the difference between the adjustment value set in one print mode and the default value is determined, then the ratio of the determined difference to the default value is determined, and then the default value of the print mode to be set is multiplied by the determined ratio and the result is added to the default value.

Note that the calculation method for determining a value for another print mode is not limited as such, but could also be a calculation method that adds the difference between the adjustment value set in the print mode 1 and the default value to the default value in the print mode 2, as shown in the second embodiment. In other words, the processing of S1905 through S1906 can be replaced with that of S1803 through S1804 in FIG. 18.

The flowchart in FIG. 19 can also be applied to the adjustment item of the “AIRFLOW VOLUME.” The range and the default value for the adjustment item of the “AIRFLOW VOLUME” are common among the print modes 1 and 2, as illustrated in the range table 530 in FIG. 12, but the default value is different for the print mode 3. Specifically, the lower limit value “2,” the default value “2,” and the upper limit value “5” are all common to the print modes 1 and 2. Further, for the print mode 3, the lower limit value is “2,” the default value is “3,” and the upper limit value is “5,” with the default value being different from the print mode 1.

Assuming that the “AIRFLOW VOLUME” in the print mode 1 is set to the adjustment value “3,” in the print mode 2, since S1903 is determined to be YES, the adjustment value “3” in the print mode 1 can be set directly in S1904 to the “AIRFLOW VOLUME” in the print mode 2. Further, for the print mode 3, S1903 is determined to be NO. Therefore, the CPU 300 can determine the value of the “AIRFLOW VOLUME” by the processing in S1905 through S1910 or by the processing in S1803 through S1807 of the second embodiment.

For example, in a case where the processing of S1803 through S1807 of the second embodiment is applied, the difference between the adjustment value set in the print mode 1 and the default value (=+1) is added directly to the default value (=3) in the print mode 2, and the value “4” is set for the “AIRFLOW VOLUME.”

This allows the CPU 300 to omit calculations and thus editing of the medium information can be performed with a small processing load.

As explained above, in the editing work of the medium information where multiple print modes are set for each medium and where multiple parameters are set for each of the multiple print modes, if the user adjusts the parameter values in one print mode, the setting values of the parameters corresponding to the other print modes are set automatically based on the adjustment values. This greatly reduces the burden on the user in the editing work of the medium information.

### (Other Embodiments)

The present disclosure can be implemented by processing of supplying a program for implementing one or more functions of the above-described embodiments to a system or an apparatus via a network or a storage medium, so that one or more processors in a computer of the system or the apparatus read out and execute the program. Further, implementation by use of a circuit (for example, an ASIC) for implementing one or more functions is also possible.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-111291, filed Jul. 6, 2023, which is hereby incorporated by reference wherein in its entirety.

What is claimed is:

1. An image forming system comprising:
an obtaining unit configured to obtain medium information in which a value for an adjustment item for controlling an image forming apparatus is set for each of a plurality of print modes;
an accepting unit configured to accept an adjustment value set by a user for the adjustment item for one print mode among the plurality of print modes; and
a setting unit configured to set a setting value, according to the adjustment value, for the adjustment item corresponding to another print mode differing from the one print mode.

2. The image forming system according to claim 1,
wherein the medium information includes a plurality of parameters for image processing, and
wherein the setting unit sets the parameters for image processing according to the adjustment value in the one print mode, and also sets the parameters for image processing according to the setting value in the other print mode.

3. The image forming system according to claim 1, further comprising
a confirming unit configured to confirm with the user whether to cause the setting unit to set the setting value for the other print mode after the adjustment value is accepted, and
wherein the setting unit sets the setting value for the other print mode in a case where the confirming unit has confirmed to cause the setting unit to set the setting value for the other print mode.

4. The image forming system according to claim 1,
wherein, in a case where it is pre-defined that a common value is to be set for the adjustment item of the accepted adjustment value in all of the plurality of print modes, the setting unit sets the same value as the adjustment value related to the adjustment item for the adjustment item corresponding to the other print mode.

5. The image forming system according to claim 4,
wherein the adjustment item includes at least one of ink drying time, automatic cut setting, head height, and paper tube size.

6. The image forming system according to claim 1,
wherein, in a case where it is defined that the adjustment item of the accepted adjustment value can be adjusted for each of the plurality of print modes, the setting unit determines and sets the setting value of the adjustment item corresponding to the other print mode, based on the adjustment value related to the adjustment item.

7. The image forming system according to claim 6,
wherein the setting unit sets, as the setting value of the adjustment item corresponding to the other print mode, a value obtained by adding a difference between the adjustment value and a predetermined default value to a default value of the adjustment item corresponding to the other print mode.

8. The image forming system according to claim 6,
wherein the setting unit determines the setting value of the adjustment item corresponding to the other print mode so as to be adjusted by the same ratio as a ratio of a difference between the adjustment value and a predetermined default value to the default value.

9. The image forming system according to claim 7,
wherein the setting unit corrects the determined setting value so as to match an increment width corresponding to a parameter for image processing included in the medium information.

10. The image forming system according to claim 7,
wherein the setting unit corrects the determined setting value so as to become a value to be accepted by a target for control of the adjustment item.

11. The image forming system according to claim 7,
wherein, in a case where the determined setting value falls outside of a predetermined range of settable values, the setting unit changes the determined setting value so as to fall within the range.

12. The image forming system according to claim 6,
wherein, if a predetermined range of settable values and a default value in the other print mode are the same as those in the one print mode, the setting unit sets the same value as the adjustment value for the setting value to be set for the adjustment item corresponding to the other print mode.

13. The image forming system according to claim 6,
wherein the adjustment item includes at least one of fixing temperature, airflow volume, airflow temperature, ink applying amount, delay between scans, and one-way printing.

14. The image forming system according to claim 1, further comprising
a display control unit configured to display a screen for accepting inputting of the adjustment value from the user, and
wherein the display control unit displays on different screens the adjustment item that is pre-defined to be set with a value common to all of the plurality of print modes and the adjustment item that is defined to be adjustable for each of the plurality of print modes.

15. A method of editing medium information, the method comprising:
obtaining medium information in which a value for an adjustment item for controlling an image forming apparatus is set for each of a plurality of print modes;
accepting an adjustment value set by a user for the adjustment item for one print mode among the plurality of print modes; and
setting a setting value, according to the adjustment value, for the adjustment item corresponding to another print mode differing from the one print mode.

16. A non-transitory computer readable storage medium storing a program which causes a computer to execute a method of editing medium information,
the method comprising:
obtaining medium information in which a value for an adjustment item for controlling an image forming apparatus is set for each of a plurality of print modes;
accepting an adjustment value set by a user for the adjustment item for one print mode among the plurality of print modes; and
setting a setting value, according to the adjustment value, for the adjustment item corresponding to another print mode differing from the one print mode.
